(19) United States
(12) Patent Application Publication
(10) Pub. No.: US 2005/0101512 A1
(43) Pub. Date: May 12, 2005

(54) Soil settling composition

(75) Inventors: Purvita Shah, Jersey City, NJ (US); Michael J. Jurek, Oak Ridge, NJ (US)

Correspondence Address: Attn: William J. Davis, Esq.;INTERNATIONAL SPECIALTY PRODUCTS, Legal Department, Building No. 8, 1361 Alps Road, Wayne, NJ, 07470, US

(73) Assignee: ISP INVESTMENTS INC.

(21) Appl. No.: 10/890,646

(22) Filed: Jul. 14, 2004

Related U.S. Application Data
(60) Provisional application No. 60/519,228, filed on Nov. 11, 2003.

(51) Int. Cl. C11D 3/37

(52) U.S. Cl. 510/475

(57) ABSTRACT

A soil settling composition which can rapidly precipitate soil in dirty water includes an aqueous solution of a settling agent which is a polymeric composition of a water soluble polymer, or copolymer thereof, optionally having in situ-formed substantially water-insoluble, crosslinked resinous particles of the polymer or copolymer substantially uniformly dispersed in the composition as a second phase.

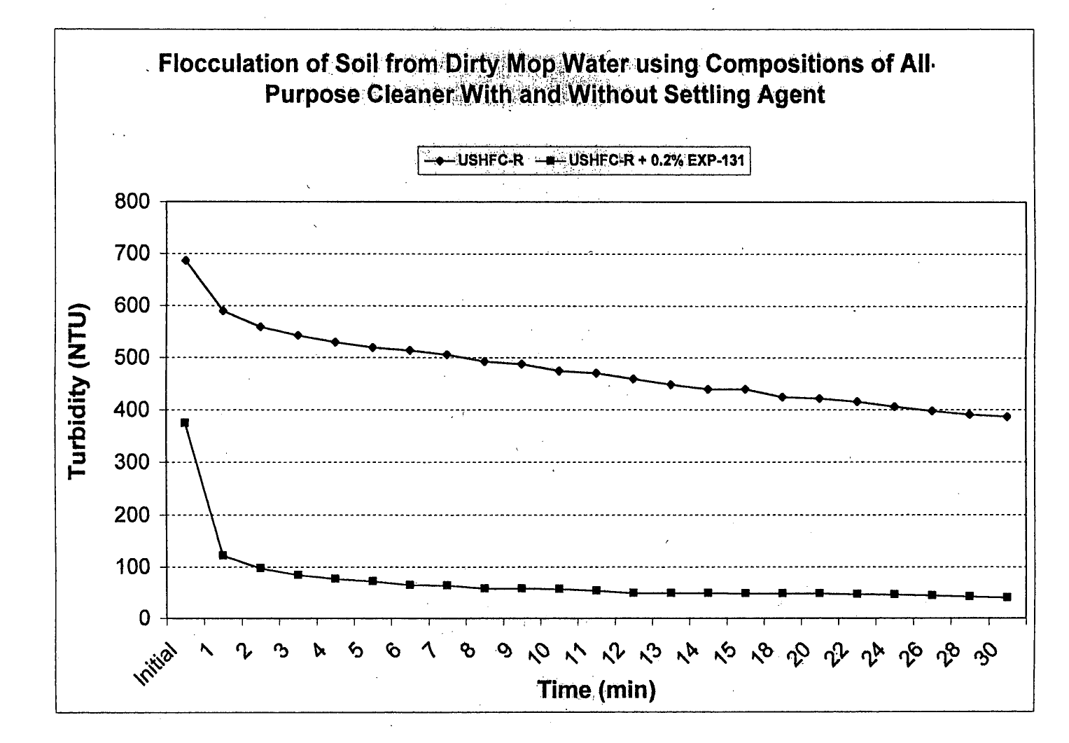

### CROSS REFERENCE TO RELATED APPLICATION

This application corresponds to U.S. Provisional Patent Application Ser. No. 60/519,228, filed on Nov. 11, 2003, the complete disclosure of which is hereby incorporated by reference.

### BACKGROUND OF THE INVENTION

Flocculation is defined as the process by which fine particles, suspended in a liquid medium, form stable aggregates called flocs. The degree of flocculation can be mathematically defined as the ratio between the numbers of particles in a system prior to flocculation to the number of particles (flocs) after flocculation. On a macroscopic scale, flocculation makes the suspension inhomogeneous.

Chemical additives that function to increase the degree of flocculation of a suspension at relatively low levels are termed flocculating agents. They typically act on a molecular level at the surfaces of the particles to reduce the repulsive forces and cause a net increase in the attractive forces. Flocculants can be classified as inorganic or organic in composition. Inorganic flocculants tend to contain di- or tri-valent metal cations while organic flocculants are typically polymeric in structure, with both natural and synthetic materials represented.

The classification of organic flocculants has historically included natural polymers such as guar gum, starch and protein albumin. The use of synthetic polymers has increased dramatically in the last decade with the use of acrylamide-acrylic copolymers and their derivatives, polyethylene glycols, polyamines and allylamine polymers. There are two main advantages of the acrylamide-acrylate based copolymers as flocculants. The first is their molecular weight can be 10-20 times higher than natural polymers. The second is the synthetic versatility to copolymerize other charged functional monomers to tailor the overall charge density to an optimum value for a given system.

For flocs to form, individual particles must move and collide together. Flocculation can be classified as either perikinetic or orthokinetic. In the first case, particle motion is the result of Brownian motion while in the latter case; it results from turbulence in the suspension. At very close distances, van der Waals dipole-induced dipole forces are the primary attractive forces present in polar materials. Particles maintain an overall negative charge in aqueous suspensions resulting from ionization of surface groups. These charged particles are surrounded in the suspension by an oppositely charged positive ion layer called the double layer. Flocculation is prevented as the charged particles approach each other at close range due to electrostatic repulsion. An increase in the ionic strength of the liquid medium reduces the repulsive forces until the particles begin to aggregate at a critical flocculation concentration. As the positive charge of the double layer is increased, the distance between the particle and the positively charged layer decreases, thus allowing the particles to approach more closely and be attracted by the van der Waals forces. The Schultze-Hardy rule determines the critical flocculation concentration of positive ions for a particular system decreases proportionally to the 6^{th} power of the charge. This double-layer compression mechanism is often cited for the action of inorganic flocculating agents that often contain di- and tri-valent ions. This mechanism can also be partially used to explain polymeric effects as the di- and tri-valent ions can exist in a pseudo-polymeric state in solution and often can precipitate as polymeric species.

The next flocculation mechanism can be termed bridging. In it, some individual segments of a very high molecular weight polymer adsorb onto a particle surface. The remainder of the polymer molecule is freely mobile in the liquid medium and is able to have additional segments adsorb onto other distinct particles. The polymer effectively functions as a bridge between particles. It must be emphasized that this mechanism depends strongly on high molecular weight polymers, lower molecular weight polymers with short chain lengths may not extend sufficiently into the medium to interact with neighboring particles and may indeed adsorb again onto the same particle. This ‘coating’ of the particle by a polymer may stabilize the particle, resulting in the opposite of the desired effect and will act to disperse the particle.

This bridging will of course be affected by the charge density and the charge density distribution on a polymer, generally anionic in nature. As the charge density on the polymer chain increases, the polymer will assume a more extended state in solution owing to the mutual anionic charge repulsion. This conformation will favor the polymer's probability of interaction with particles and hence, bridging. One cannot continue to increase the charge density of the polymer, as it will eventually interfere with its ability to adsorb onto the anionically charged particles. An increase in the ionic content of the medium would aid adsorption; however, the high ionic charge would now surround the high charge density on the polymer chains, leading to a less extended conformation. One can see that there will be an optimum combination for charge density of both the polymer and liquid medium.

The bridging mechanism will also function with cationic polymers and copolymers, provided that their molecular weights are sufficiently high. One can envision that the interactions between an anionically charged particle and a cationically charged polymeric flocculating agent would be more straightforward in their interactions. It would approach the particle in a “flat” configuration with fewer polymeric loops to interact with additional particles.

A third mechanism of flocculation is electrostatic in nature and is referred to as the charge patch mechanism. For this example, a highly charged cationic polymer is adsorbed onto a negatively charged particle and as these oppositely charged materials interact, more of the polymer can be adsorbed onto the particle. The overall effect will be to reduce the size of the electric double layer as the net charge density on the particle is reduced. With the interparticle repulsive effect of the double layer reduced, flocculation capability is enhanced, an effect known as charge neutralization. As polymer adsorption on a particle increases, the particle's net charge may pass to a net positive charge due to the high charge density on the polymer. These positively charged particles might now be attracted to other negatively charged particles in suspension, which is called heterocoagulation.

A lesser-used mechanism is used primarily in water clarification or in suspensions that do not respond well to polymeric flocculants and is referred to as sweep flocculation. In general terms, solids are deliberately added to a suspension and then flocculated with a high molecular weight polymer. During the bridging mechanism flocculation that occurs, much of the original material is trapped in the flocculation of the added material and is subsequently also removed from the system.

Theoretical predictability of the flocculation effectiveness in a particular system is generally less than desirable. Most systems require experimental verification to select an optimum method/polymer for any particular suspension. In any testing, the main components of interest remain; the type of particle (substrate), the type of flocculent and the type of mechanical treatment of the system. Although one may consider the degree of flocculation to be paramount, it is the size and physical properties of the flocs formed that dictate the practical effectiveness in any specific application.

Settling agents (SA) are chemical additives that cause suspended solids to form agglomerates and increase settling in primarily water-based applications. A benefit of formulating these agents in all-purpose cleaners is that the product can be used for a longer time since the dirty water appears cleaner via flocculation of the dirt to the bottom. Flocculation in water-based cleaners at active (SA) levels of 0.4 wt. % or lower is particularly desirable.

### SUMMARY OF THE INVENTION

A soil settling composition which can rapidly precipitate soil in dirty water includes an aqueous solution of a settling agent which is a polymeric composition of a water soluble polymer, or copolymer thereof, optionally having in situ-formed substantially water-insoluble, crosslinked resinous particles of the polymer or copolymer substantially uniformly dispersed in the composition as a second phase.

Suitable polymers include polyvinylpyrrolidone (PVP), or polyvinyl caprolactam (PVCL), and copolymers of PVP or PVCL and one or more comonomers.

A preferred comonomer is dimethylaminopropyl(meth) acrylamide (DMAPMA) or dimethylaminoethyl (meth) acrylate (DMAEMA).

These two-phase polymeric systems are described in detail in U.S. Pat. No. 6,548,597, the entire contents of which are incorporated by reference herein.

A typical copolymer has a wt. ratio of 80:20 PVP:DMAPMA, preferably as the HCl salt.

The two-phase polymer systems are made by providing a reaction mixture of a water soluble vinyl monomer, optionally with one or more comonomers, a predetermined amount of a crosslinking agent and water, heating the mixture, then periodically adding a predetermined amount of an initiator, such as an azo initiator; and polymerizing at about 30-130° C.

Suitably the settling agent is present in the composition of the invention in an amount, by wt., of at about 0.005 to 0.8 wt. %, of the composition, preferably 0.05 to 0.4 wt. %.

### IN THE DRAWING

The FIGURE illustrates the settling performances of typical compositions of the Invention vs. a Control.

### DETAILED DESCRIPTION OF THE INVENTION

The effectiveness of a given flocculating agent was determined by measuring the haze level produced in a known volume of a dirt suspension. A Hach Turbidimeter was employed for these measurements. Several sources of dirt were screened to determine if a specific material had a useful range; among them were household or industrial floor cleanings, certified dirt standards and common store brand top soil. Each dirt source was evaluated with a polymeric flocculating agent at different use levels, from 0.005 to 0.4 wt. %.

Haze measurements were obtained at several time intervals, from 15 minutes to 1 hour and up to 24 hours later. Haze readings were initially high for the control, which remained relatively stable for several days. The flocculating agents of the invention decreased the haze values significantly within 15 minutes or less and continued to improve the clarity of the solutions for 24 hours or more.

The Control was a commercial all-purpose household floor cleaner USHFC-R (Regular) containing non-ionic surfactant and monoethanolamine.

The Invention composition was the same household floor cleaner, however, including the invention soil settling agent as additive.

A set of quantitative experiments were run using two different formulations: (i) USHFC-R (Regular), and (ii) USHFC-R (Regular) formula with 0.2% EXP-131* as the invention settling agent. All formulations were applied separately on different areas to mop the floor for actual testing. Approximately, 1.5 L of tap water was used with 50 g of each formulation, and, at the end, all three solutions were collected.
* EXP-131 is a 2-phase polymeric composition of vinyl pyrrolidone (VP) and dimethylaminopropyl methacrylamide (DMAPMA) in a weight ratio of 80:20, as the HCl salt (U.S. Pat. No. 6,548,597, Ex. 1). (ISP) as a 20% active copolymer in water.

Results

A turbidity reading of each sample was measured using a Hach ratio turbidimeter. In the first experiment, initial haze and haze after 1 hour were monitored, but haze after 1 day yielded additional information about the interactions between the dirt and the polymer. When dirt settles faster it gives lower haze readings. The settling test results are shown in the FIGURE below vs control samples. Then invention settling agent, designated EXP-131 worked exceptionally well by attracting the dirt particles, which flocculated and coagulated into a precipitate. This precipitate became heavy and dropped to the bottom of the mop bucket, which then made the water appear dirt-free.

Haze readings were taken over 30 minutes to quantify how fast dirt settled in the floor cleaner formulations tested (USHFC-R and USHFC-R with EXP-131).

The FIGURE shows that the USHFC-R+0.2% EXP-131 formulation had a low initial haze that rapidly dropped to its lowest values over the next 30 minutes. EXP-131 is an exceptional settling agent enhancing both appearance and cleanliness of hard surface cleaners.

Similarly, a single phase copolymer system of 80:20 VP:DMAPMA in the same wt. amounts showed very effective settling activity as EXP-131; it had an initial haze value of only 400 NTU.

While the invention has been described with particular reference to certain embodiments thereof, it will be understood that changes and modifications may be made which are within the skill of the art. Accordingly, it is intended to be bound only by the following claims, in which:

1. A soil settling composition which can rapidly precipitate soil in dirty water comprises an aqueous solution of a settling agent which is a polymeric composition of a water soluble polymer, or copolymer thereof, optionally having in situ-formed substantially water-insoluble, crosslinked resinous particles of the polymer or copolymer substantially uniformly dispersed in the composition as a second phase.

2. A composition according to claim 1 wherein the settling agent is present in an amount, by wt., of about 0.005 to 0.8% of the composition.

3. A composition according to claim 3 wherein the settling agent is present in an amount of 0.05 to 0.4%.

4. A composition according to claim 1 wherein the settling agent is a copolymer composition of vinyl pyrrolidone and dimethylaminopropyl methacrylamide or vinyl pyrrolidone and dimethylaminoethyl (meth)acrylate.

5. A composition according to claim 4 wherein said copolymer has a wt. ratio of 80:20 of said monomers.

6. A composition according to claim 1 which is an all-purpose floor cleaner.
